(19) United States
(12) Patent Application Publication
(10) Pub. No.: US 2015/0051955 A1
(43) Pub. Date: Feb. 19, 2015

(54) SYSTEMS AND METHODS FOR AUTOMATIC PRICE MATCHING

(71) Applicants: Satish V. Kumar, Austin, TX (US); Kamal Zamer, Austin, TX (US); Jayasree Mekala, Austin, TX (US); Joseph Paulson, Austin, TX (US); Praveen Nuthulapati, Austin, TX (US)

(72) Inventors: Satish V. Kumar, Austin, TX (US); Kamal Zamer, Austin, TX (US); Jayasree Mekala, Austin, TX (US); Joseph Paulson, Austin, TX (US); Praveen Nuthulapati, Austin, TX (US)

(21) Appl. No.: 13/968,279

(22) Filed: Aug. 15, 2013

(51) Int. Cl. G06Q 30/02

(52) U.S. Cl. CPC G06Q 30/0206
USPC 705/7.35

(57) ABSTRACT

When a consumer selects and checks out merchandise at a point of sale of a merchant, price matching is automatically performed for the selected merchandise and the merchant has the opportunity to price match competitors' prices. The price of the merchandise is automatically adjusted based on the merchant's price matching policy. Thus, the customer may receive the benefit of price matching automatically during the checkout process. Further, prices offered at the merchant and at the competitors are continuously monitored for a period of time after purchase. When lower prices are found during the period of time, the purchase price is automatically adjusted and the amount difference between the purchase price and the lower price is automatically refunded to the customer's payment account.

### BACKGROUND

1. Field of the Invention

The present invention generally relates to systems and methods for implementing price matching in retail commerce.

2. Related Art

In today's diverse retail commerce, consumers have many choices of merchants when purchasing goods or services. For example, a consumer may shop for the same widget from a variety of merchants including online merchants, department stores, and specialty stores. Because of the large number merchant choices, it becomes increasingly tedious and time consuming for a consumer to compare prices for the same widget sold at many available merchants and determine the best price for the same widget. Although some merchants provide price matching guarantee, in which the merchant may match other competitors' price, the consumer still needs to spend time and effort searching for a better price offered at the other competitors and present the better price to the merchant in order to receive the benefit of the price matching guarantee. Thus, there is a need for a system or method that allows automatic price matching at the point of sale (POS).

### BRIEF DESCRIPTION OF THE FIGURES

FIG. 1 is block diagram of a networked system suitable for implementing a process for automatic price matching in retail commerce according to an embodiment.

FIG. 2 is a flowchart showing a process for automatic price matching at POS according to one embodiment.

FIG. 3 is a flowchart showing a process for automatic price matching for a certain period of time according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, when a consumer selects and checks out merchandise at a merchant, price matching is automatically performed for the selected merchandise and the merchant may have the opportunity to price match the competitors' prices. Thus, the consumer may receive the best price for the selected merchandise automatically, without spending time and effort to shop for the best price. For example, when a consumer uses a payment service, such as PayPal, Inc. of San Jose, Calif., to make a purchase, the payment service may receive purchase information including the prices and identities of the items being purchased and may compare the prices of the items with the prices of the same items offered at nearby competing merchants. The payment service may allow the merchant to match any lower prices offered at the competing merchants. Thus, there is no need for the consumer to spend time and effort in shopping for the best deal.

According to one embodiment, the merchant may provide price matching for a period of time, such as ten days. Thus, after the consumer purchased the items from the merchant, the payment service may continue to monitor the prices of the purchased items for the price matching period. If a better price is found during the price matching period, the payment service may automatically refund the consumer the difference between the purchased price and the lower price found during the price matching period. Thus, there is no need for the consumer to continue to monitor the prices of the purchased items during the price matching period. By using the above methods of automatic price matching, the consumer no longer needs to spend time and effort shopping for the best price. The automatic price matching provides assurance to consumers that they automatically receive the best prices when using the payment service at the merchant.

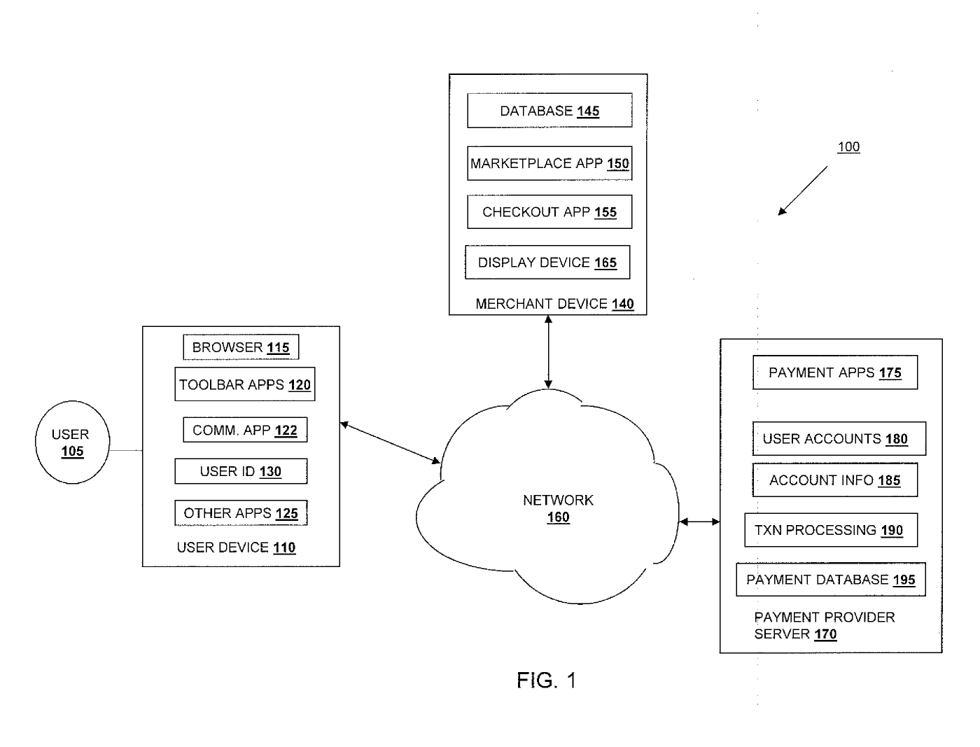

FIG. 1 is a block diagram of a networked system 100 configured to facilitate a process for automatic price matching in retail commerce in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant device 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. A user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant device is shown, a plurality of merchant devices or servers may be utilized if the user is purchasing gifts from multiple merchants. In one embodiment, user 105 may utilize merchant device 140 to initiate a payment transaction. For example, user 105 may use a payment authorization device at a merchant's store to initiate a payment transaction by swiping a payment card or entering/scanning an authorization code.

User device 110, merchant device 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a gift list and/or merchant sites for viewing and purchasing gifts. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant device 140 may be maintained, for example, by a merchant or seller offering various products and/or services. The merchant may have a physical point-of-sale (POS) store front. In one embodiment, the merchant may be a participating merchant who has a merchant account with the payment service provider. Merchant device 140 may be used for POS or online purchases and transactions. Generally, merchant device 140 may be a server maintained by anyone or any entity that receives money, which includes charities as well as retailers and restaurants. For example, a recommended gift may be a donation to charity in the name of the recipient. Merchant device 140 includes a database 145 identifying available products and/or services (e.g., collectively referred to as items) which may be made available for viewing and purchase by user 105. Further, database 145 may store information defining a price match policy for the merchant. Merchant device 140 also includes a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant device 140 also includes a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID).

Checkout application 155 may be configured to receive payment via a plurality of payment methods including cash, credit cards, debit cards, checks, money orders, or the like. The merchant device 140 may also include a display device 165 for displaying purchase or payment information to a customer. In one embodiment, display device 165 may be connected to merchant device 140 via a wire line or wireless. Display device 165 may receive purchase or payment information from merchant device 140 and may display the information accordingly. Display device 165 may include input devices, such as a key pad or a touch screen, by which a customer may input instructions in response to the displayed information. For example, merchant device 140 may forward purchase information to be displayed on display device 165. The customer may review the purchase information on display device 165 and may confirm the purchase by inputting instructions using the input device at display device 165.

Payment provider server 170 may be maintained, for example, by an online payment service provider which may provide payment between user 105 and the operator of merchant device 140. In this regard, payment provider server 170 includes one or more payment applications 175 which may be configured to interact with user device 110 and/or merchant device 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Account information may also include user purchase history and user ratings. Profiles for merchants may be included in account information. Offers or price matching policies from merchants may also be stored with account information 185. Advantageously, payment application 175 may be configured to interact with merchant device 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant device 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, identities of purchased items, prices of purchase items, price matching policies, and etc. Payment application 175 may be further configured to determine the existence of and to manage accounts for user 105, as well as create new accounts if necessary, such as the set up and management payments by the user after the initial purchase (e.g., purchase amount adjustment after purchase).

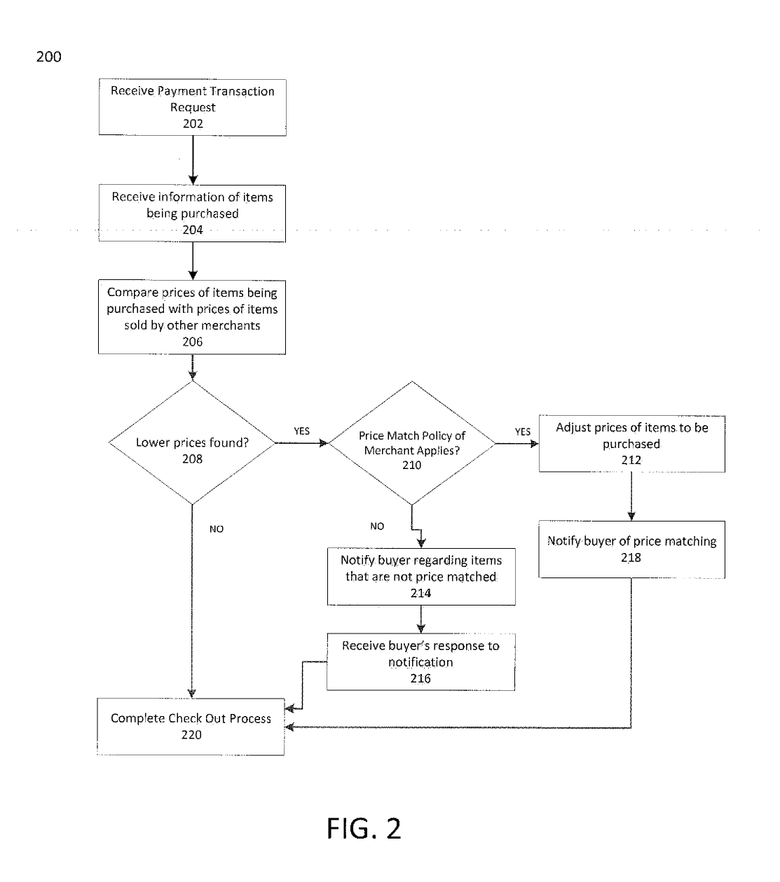

FIG. 2 is a flowchart showing a process 200 for automatic price matching at a POS according to one embodiment. Initially, a customer may select items for purchase at a merchant. The merchant may be an online merchant or a brick-and-mortar store. When the customer finishes shopping and is ready to pay for the selected items, the customer may begin a checkout process to pay for the selected items. For example, at an online merchant's website, the customer may select a checkout button on the merchant's webpage to initiate the checkout process. At a brick-and-mortar store, the customer may begin the checkout process at a checkout counter. After continuing the items to be purchased, the merchant may provide the customer with various methods of payment. For example, choices of payment methods may be displayed at display device 165 of merchant device 140 or at user device 110 and the customer may select a payment method.

The customer may select a payment service, such as PayPal, Inc. of San Jose, Calif., to facilitate payment. At step 202, merchant device 140 may forward the customer's payment transaction request to payment provider server 170. The payment transaction request may include identity of the customer and authentication for a payment account at the payment service provider. For example, the customer may enter or scan a code identifying a payment account at the payment service provider to be used for payment.

At step 204, merchant device 140 may send information regarding identities of items being purchased and prices of items being purchased to payment provider server 170. The identities of the purchased items may include Universal Product Codes (UPC), product specifications, manufacturer, model number, pictures, or the like. The prices of the purchased items may be the actual purchasing prices of the items including discounts or coupons, sales tax, shipping and handling cost, and etc.

At step 206, payment provider server 170 may perform price comparison of the items being purchased based on the price matching policy of the merchant. For example, payment provider servicer 170 may store the price matching policy of the merchant indicating the price matching geographical region, price matching competitors, and the like. For example, if the price matching geographical region indicates Austin, Tex., the merchant matches the prices of the same item sold by other merchants located within Austin, Tex. Price matching policy also may identify main competitors of the merchant whose prices the merchant wishes to match. Price matching policy also may indicate online merchants whose prices the merchant wishes to match.

Payment provider server 170 may retrieve pricing information from the other merchants via the Internet. In one embodiment, payment provider server 170 may maintain a database storing pricing information of products from various merchants and may update the pricing information periodically. Payment provider server 170 may search and identify lowest prices of the same items being purchased and compare these lowest prices with the actual purchasing prices of the items offered at the merchant. In one embodiment, prices of similar products offered at the other merchants also may be searched and included in the price comparison. Price matching policy may indicate whether only identical products are searched or similar products are allowed in the price comparison. In the price comparison process, Payment provider server 170 may take into account additional costs, such as taxes, shipping, and the availability of the items, such as estimated shipping time.

At step 208, payment provider server 170 may determine whether lower prices are found for the items being purchased within the geographical area or from main competitors, as defined by the price matching policy. If no lower prices are found at step 208, payment provider server 170 may complete the checkout process at step 220. For example, payment provider server 170 may debit the purchase amount from the customer's payment account and credit the purchase amount to the merchant's account. In an embodiment, payment provider server 170 may notify the customer that price matching has been performed and that the merchant has the best price.

If lower prices are found at step 208, payment provider server 170 may confirm whether the lower prices from other merchants qualify for price matching based on the price matching policy at step 210. For example, payment provider server 170 may confirm whether the items being purchased are designated by the merchant for price matching. The merchant may restrict certain products from being price matched. Further, individual sellers may post personal items for sale on the internet at much lower prices than those sold by business merchants. Such personal items sold by individual sellers usually do not include product warranty and has no after-sale return or service policy. Thus, the merchant may restrict price matching policy from being applied to items sold by online individual sellers.

When payment provider server 170 determines that the items qualify for price matching at step 210, payment provider server 170 may adjust prices of items to be purchased based on the lower prices found and the price matching policy. For example, based on the price matching policy, payment provider server 170 may reduce the purchasing prices to be the same as the lower prices found. In one embodiment, payment provider server 170 may adjust the purchasing prices to be slightly lower than the lower prices found, based on the price matching policy. In one embodiment, the adjustment is done automatically at checkout.

At step 218, payment provider server 170 may send price matching information to notify the customer. For example, payment provider server 170 may send the price matching information to merchant device 140 to be displayed on display device 165. The customer at a brick-and-mortar store may be notified of the price matching by viewing display device 165. In one embodiment, payment provider server 170 may send the price matching information to user device 110 to notify the customer. The price matching information may indicate the original prices and the reduced prices after price matching. The price matching information also may indicate the savings resulted from the automatic price matching. Thus, the customer may be notified of the savings received by using the payment service and shopping at the merchant. Such notification may increase the customer's loyalty toward the payment service or the merchant.

In addition, the customer may be requested to confirm the price matching. Payment provider server 170 may receive confirmation from the customer and finalize the prices of the items to be purchased. At step 220, payment provider server 170 may complete the checkout process by debiting from the customer's payment account and crediting the merchant's account based on the finalized purchasing prices.

If the price matching policy of the merchant does not apply to the lower prices found at step 210, payment provider server 170 may notify the customer regarding items that are not matched by the merchant at step 214. For example, payment provider server 170 may send lower-price information to merchant device 140 to be displayed to the customer on display device 165 at the checkout counter. In one embodiment, payment provider server 170 may send the lower-price information to user device 110 to be displayed to the customer.

The lower-price information may include the amount of the lower price and the identity of the competing merchant that offers the lower price. The lower-price information also may display the location and distance of the competing merchant and the availability of the same item being purchased at the competing merchant. For example, the customer may be notified that the competing merchant is located within one mile and that the item is available in three days. For online competing merchants, the customer may be notified of the estimated delivery time for the item. The customer also may be notified of the price difference. Thus, the customer may have adequate information to determine whether to purchase the items from the competing merchant.

The customer may be requested to indicate whether to proceed with purchasing the non-price matched items. The customer may choose whether to purchase the non-price matched items by entering the choices at merchant device 140 or at user device 110. At step 216, payment provider server 170 may receive the customer's response from merchant device 140 or user device 110. Based on the customer's response, payment provider server 170 may adjust the purchased items and recalculate the purchase amount. At step 220, payment provider server 170 may complete the checkout process by debiting from the customer's payment account and crediting the merchant's account based on the finalized purchase amount.

The above automatic price matching process allows the payment service to price match automatically at POS based on a merchant's price matching policy. Thus, a customer no longer needs to spend time and effort in shopping for best prices. Further, the payment service or the merchant may develop customer loyalty by providing best price assurance customers.

The following is an exemplary scenario in which the automatic price matching process may be implemented,

### Scenario 1

A customer purchases a hammer at a local brick-and-mortar hardware store. The hardware store has a price matching policy. At the checkout counter, the customer chooses a payment service to pay for the hammer. For example, the customer uses a payment device at the checkout counter to choose a payment method and enters a code to initiate a payment request to the payment service. The payment service receives the payment request along with the UPC of the hammer or the specification of the hammer and the purchase price of the hammer.

Based on the hardware store's price matching policy, the payment service compares the price of the hammer at the hardware store with the prices of the same hammer sold at other competing hardware stores in the region. Based on the price matching policy of the hardware store, prices of similar hammers also may be compared. Further, prices of the same or similar hammer sold at online merchants also may be compared with the price of the hammer sold at the hardware store. The payment provider automatically adjusts the price of the hammer based on the price matching policy of the merchant and notifies the customer of the automatic price matching and the resulted saving. The customer confirms the price matching and finalizes the purchase.

If the hardware store does not price match because the competing lower price is offered by an online merchant, the customer is notified with the amount of the lower price, the identity of the online merchant including web address, and delivery time and cost for the hammer from the online merchant. Based on this information, the customer may decide whether to purchase the hammer from the online merchant instead. For example, the customer may decide to purchase the hammer from the hardware store without price matching, because the customer needs the hammer immediately and cannot wait for the lower priced hammer to be delivered from the online merchant.

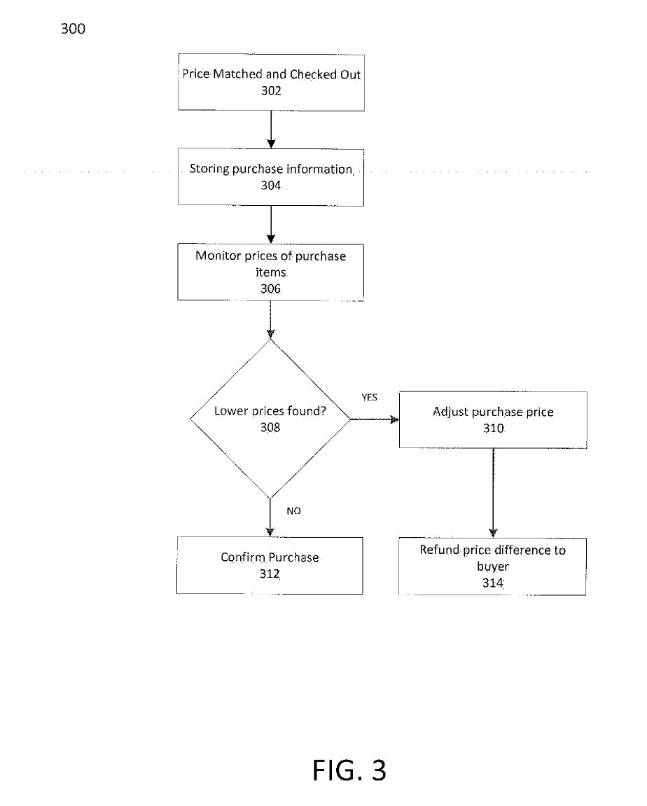

FIG. 3 is a flowchart showing a process for automatic price matching for a period of time according to an embodiment. The process of price matching may begin after a purchase is completed at a merchant. At step 302, the customer may have finished checking out and paid for the items purchased at the merchant. The merchant may have a price matching policy that allows price matching for a period of time, such as ten days. At step 304, payment provider server 170 may store the purchase information after the purchase. The purchase information may include prices paid for the purchased item, purchase time and date, identity of the purchased item, and etc.

At step 306, payment provider server 170 may monitor the prices of the items, which are the same or similar to the purchased items, offered at the merchant or at competing merchants, based on the price matching policy. Payment provider server 170 may continuously monitor the prices of these items for the period of price matching. For example, payment provider server 170 may check the prices of these items offered at the merchant or at other competing merchants every day for ten days. At step 308, payment provider server 170 may determine whether any lower prices are found during the price matching period. For example, payment provider server 170 may capture the lowest price for the purchased item during the price matching period of time and compare the lowest price captured during the price matching period of time with the purchase price.

If no lower price is found during the price matching period at step 308, payment provider server 170 may confirm the purchase at step 312. For example, payment provider server 170 may notify the customer that the price matching period has expired and that no other lower price was found during the price matching period.

If a lower price was found during the price matching period at step 308, payment provider server 170 may adjust the purchase price to match the lower price, based on the merchant's price matching policy, at step 310. For example, the payment provider server 170 may adjust the purchase price to be the same or lower than the lowest price captured during the price matching period. At step 314, the payment provider server 170 may automatically refund the price difference back to the customer's payment account. In one embodiment, the payment provider server 170 may send a message or notification to inform the customer that a lower price was found during the price matching period, that automatic price matching was honored by the merchant, and that a price difference has been credited to the customer's payment account. Thus, the customer may be notified of the price matching activity and may develop loyalty toward the payment service provider and the merchant.

The followings are exemplary scenarios in which the above processes for automatic price matching at POS and for a period of time may be implemented.

### Scenario 2

A customer purchases a hammer on July 8, from a local brick-and-mortar hardware store that provides a “get the best price within 10 days” guarantee. The customer pays $25.99 for the hammer. After the purchase, the payment service provider determines that the hardware store has a price matching policy for 10 days starting from the day of purchase. The payment service provider sets up a price watch for the hammer sold at the hardware store and/or at the other competing merchants until July 18. The payment service provider captures a lower price for the hammer at $23.99 on July 10. The price of the hammer increased to $24.99 on July 13. On July 15, a new lower price of $22.99 for the hammer is captured. The payment service provider continues to monitor the price of the hammer until July 18. The payment service provider determines that the lowest price during the price marching period is $22.99. The payment service provider confirms the price matching policy with the merchant and credits the difference between the purchase price and the lower price to the customer's payment account.

### Scenario 3

An online store offers price matching policy to match prices of other online merchants and local brick-and-mortar stores that are within five miles of the customer.

Further, the price matching policy offers to provide prepaid return shipping in the event that a local brick-and-mortar store offers a better price for the hammer. A customer selects a hammer from the online store. The hammer has a listing price of $25.99 and $3.99 for shipping. At the checkout process, the customer uses the payment service provider to pay for the purchase on July 8. The payment provider service automatically compares the purchase price including tax and shipping with prices for the hammer offered at other online merchants. Further, the payment provider service requests that the customer provide a location of the customer, such as an address or zip code. The payment provider service uses the location of the customer to compare prices for the hammer offered at brick-and-mortar stores within five miles of the location of the customer.

The payment provider service determines that a brick-and-mortar store offers a price of $28.13 for the same hammer including tax, and without shipping cost. The payment service provider confirms with the online merchant for matching the lower price of $28.13 and prepaid return shipping. The payment provider service adjusts the purchase price to the better price at the checkout. The payment provider service notifies the customer of the price matching and the offer of prepaid return shipping. Thus, the customer may have adequate information to decide whether to proceed with the purchase at the online store. The customer accepts the price match offer and completes the purchase at the online store. The payment service provider completes the payment transaction and notes the offer of prepaid return shipping for further reference.

The customer receives the hammer shipped from the online store. The customer decides to return the hammer because it is not suitable for use. The customer requests a Return Merchandise Authorization (RMA) from the online store. The online store honors the previously offered return policy and sends a prepaid return packaging to the customer. The customer sends the hammer back to the online store using the prepaid return packaging. The payment service provider confirms the return of the hammer with the online store and refunds the purchase price to the customer's payment account.

Accordingly, by utilizing automatic price matching at POS, the customer no longer needs to spend time and effort in shopping for best prices. Further, the merchant and the payment service provider may develop customer loyalty by offering assurance of automatic price matching to the customers.

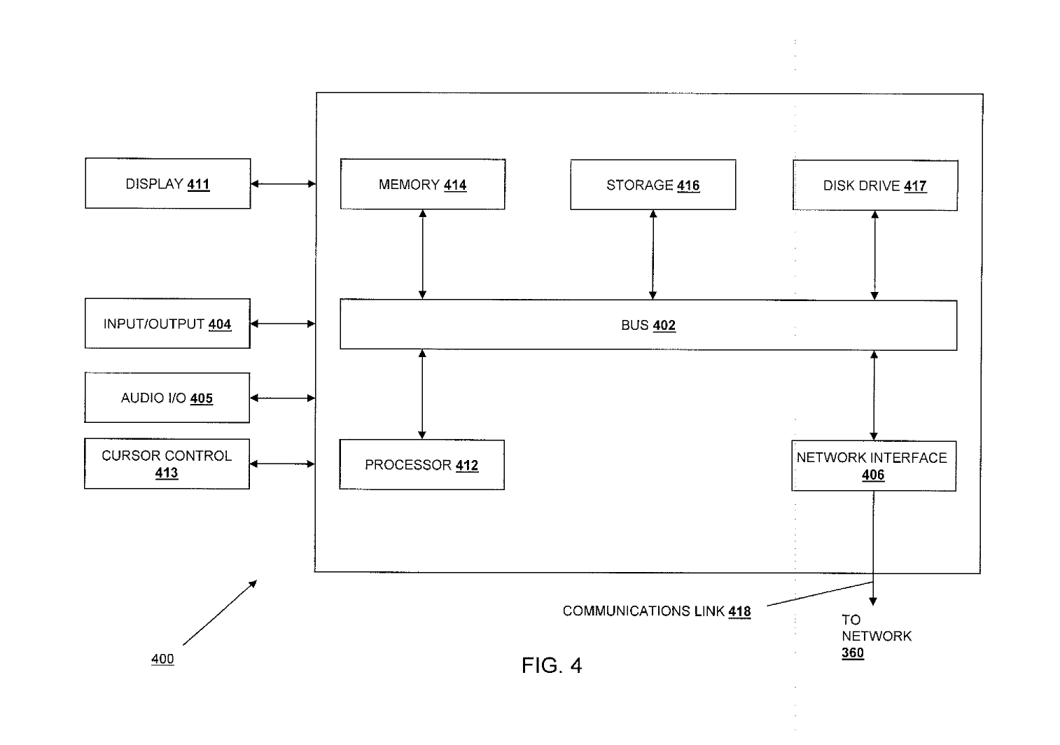

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for automatic price matching, the system comprising:
one or more processors adapted to:
receive, electronically by a payment service provider, a payment request for purchasing a product from a merchant using a payment account of a payer;
receive price and product information of the product;
in response to receiving the payment request, compare a purchasing price of the product at the merchant with a price of the product offered at another merchant based on a price matching policy of the merchant.

2. The system of claim 1, wherein the one or more processors is further adapted to:
adjust the purchasing price of the product at the merchant based on the comparison; and
notify the payer regarding the adjustment to the purchasing price;

3. The system of claim 1, wherein the one or more processors is further adapted to:
notify the payer that the price of the product offered at another merchant is lower than the purchasing price when the purchasing price is not adjusted based on the price matching policy of the merchant; and
receive the payer's selection of whether to proceed with purchasing the product from the merchant.

4. The system of claim 1, wherein the comparing the purchasing price of the product comprises:
retrieving a price of the product or similar product offered at the another merchant; and
comparing the purchasing price of the product at the merchant with the price of the product offered at the another merchant including tax and shipping cost.

5. The system of claim 1, wherein the one or more processors is further adapted to:
monitor a price of the product offered at the merchant and at other merchants for an extended period of time after completion of purchase;
determine a lowest price of the product offered during the extended period of time;
compare the lowest price determined during the extended period of time with the purchase price of the product; and
refund a difference between the lowest price determined during the extended period of time and the purchase price of the product to the payer when the lowest price determined during the extended period of time is lower than the purchase price.

6. The system of claim 1, wherein the price matching policy defines a geographical region within which price matching is honored by the merchant

7. The system of claim 1, wherein the price matching policy defines types of competing merchants against which price matching is honored by the merchant.

8. A method for automatic price matching, the method comprising:
receiving, electronically by a processor of a payment service provider, a payment request for purchasing a product from a merchant using a payment account of a payer;
receiving price and product information of the product;
in response to receiving the payment request, comparing a purchasing price of the product at the merchant with a price of the product offered at another merchant based on a price matching policy of the merchant.

9. The method of claim 8 further comprising:
adjusting the purchasing price of the product at the merchant based on the comparison; and
notifying the payer regarding the adjustment to the purchasing price;

10. The method of claim 8 further comprising:
notifying the payer that the price of the product offered at another merchant is lower than the purchasing price when the purchasing price is not adjusted based on the price matching policy of the merchant; and
receiving the payer's selection of whether to proceed with purchasing the product from the merchant.

11. The method of claim 8, wherein the comparing the purchasing price of the product comprising:
retrieving a price of the product or similar product offered at the another merchant; and
comparing the purchasing price of the product at the merchant with the price of the product offered at the another merchant including tax and shipping cost.

12. The method of claim 8 further comprising:
monitoring a price of the product offered at the merchant and at the another merchant for an extended period of time after completion of purchase;
determining a lowest price of the product offered during the extended period of time;
comparing the lowest price determined during the extended period of time with the purchase price of the product; and
refunding a difference between the lowest price determined during the extended period of time and the purchase price of the product to the payer when the lowest price determined during the extended period of time is lower than the purchase price.

13. The method of claim 8, wherein the price matching policy defines a geographical region within which price matching is honored by the merchant.

14. The method of claim 8, wherein the price matching policy defines types of competing merchants against which price matching is honored by the merchant.

15. A non-transitory machine-readable medium comprising a plurality of machine-readable instructions which when executed by one or more processors of a server are adapted to cause the server to perform a method comprising:
receiving, electronically by a payment service provider, a payment request for purchasing a product from a merchant using a payment account of a payer;
receiving price and product information of the product;
in response to receiving the payment request, comparing a purchasing price of the product at the merchant with a price of the product offered at another merchant based on a price matching policy of the merchant.

16. The non-transitory machine-readable medium of claim 15, wherein the method further comprises:
adjusting the purchasing price of the product at the merchant based on the comparison; and
notifying the payer regarding the adjustment to the purchasing price;

17. The non-transitory machine-readable medium of claim 15, wherein the method further comprises:
notifying the payer that the price of the product offered at another merchant is lower than the purchasing price when the purchasing price is not adjusted based on the price matching policy of the merchant; and
receiving the payer's selection of whether to proceed with purchasing the product from the merchant.

18. The non-transitory machine-readable medium of claim 15, wherein the comparing the purchasing price of the product comprises:
retrieving a price of the product or similar product offered at the another merchant; and
comparing the purchasing price of the product at the merchant with the price of the product offered at the another merchant including tax and shipping cost.

19. The non-transitory machine-readable medium of claim 15, wherein the method further comprises:
monitoring a price of the product offered at the merchant and at other merchants for an extended period of time after completion of purchase;
determining a lowest price of the product offered during the extended period of time;
comparing the lowest price determined during the extended period of time with the purchase price of the product; and
refunding a difference between the lowest price determined during the extended period of time and the purchase price of the product to the payer when the lowest price determined during the extended period of time is lower than the purchase price.

20. The non-transitory machine-readable medium of claim 15, wherein the price matching policy defines a geographical region within which price matching is honored by the merchant.
